(19) United States
(12) Patent Application Publication
(10) Pub. No.: US 2004/0107244 A1
(43) Pub. Date: Jun. 3, 2004

(54) Scalable and intelligent network platform for distributed system

(76) Inventors: Hung-Chi Kuo, Feng-Shan City (TW); Fong-Jung Kuo, Feng-Shan City (TW); Ming-Chang Kao, Taipei (TW); Chia-Ming Lee, Kaohsiung (TW)

Correspondence Address: DELLETT AND WALTERS, P. O. BOX 2786, PORTLAND, OR, 97208-2786, US

(21) Appl. No.: 10/308,349

(22) Filed: Dec. 2, 2002

(51) Int. Cl. G06F 15/16

(52) U.S. Cl. 709/203

(57) ABSTRACT

A scalable and intelligent network platform for distributed system has at least one application server and multiple connected endpoint machines, which is capable of supporting commonly used data formats and message exchange protocols. This network platform enables endpoint machines running on different operating systems and using different message exchange protocols to perform downloading or access network drives. The network platform also allows remote clients in different domain to log onto the application server cross platform to obtain a copy of the frequently used program software for downloading. The present invention provides a management model for computer resources in the Intranet environment with a highly flexible architecture.

### BACKGROUND OF THE INVENTION

1. Field of the Invention

The present invention relates to a scalable and intelligent network platform that includes multiple endpoint machines and a server connected through an integrated conversion, through which endpoint machines are able to obtain the most updated program software and disk space on network drives.

2. Description of Related Arts

With reference to FIG. 5, Intranet generally refers to an internal computer network of a large organization or large company which is composed of an application server linking with many computer terminals or endpoint machines.

In the early days, a powerful mainframe computer was built to manage all computer resources. However, this type of server (50) capable of processing massive data usually is so expensive that small companies or ordinary users often cannot afford such high costs.

To make the network applications more affordable for ordinary users, it is necessary to distribute some of the computing tasks among several task managers, each of which takes care of a single task, while the host computer only handles the basic command invocation. The file server and printer server are some of these examples, which provide services no more than resource pooling or sharing among all system users.

In the late 80's, a server (60) with the powerful computing ability was developed that enabled an executable program to be divided up into various stages for parceling them out to multiple distributed computers (61), so as to lessen the memory and disk space requirement on the server (60). As shown in FIG. 6, each distributed computer (61) performs front-end processing on the local machine, and then passes the intermediate data to the application server (60) for back-end processing through the existing Intranet connection.

The Internet is now used by millions of people all over the world. The World Wide Web (referred to herein as the “web”) is that portion of the internet that uses the HTTP protocol for exchanging messages. Web-page development and browser programs enable Intranet users to link across to the internet platform. Web servers such as IIS Server, Exchange Server, and Apache Server can provide Intranet users with the Internet services. However, the problem with earlier versions of the web-page development programs is that their output presentation is stationary, which cannot support applications using dynamic web-page. They need additional driver overlay, such as common gateway interface (CGI), to synchronize with the network server. This kind of network server therefore cannot meet the needs of the future.

To allow current Intranet users to be able to access the internet with dynamic web page applications, the program design involves message exchange protocols and software programming such as TCP, HTTP, XML, Logger, authentication, database programs, LDAP, and smart card networking, and related hardware facilities also have to be updated to meet the above requirements. There is also the problem of authorization limit for different users trying to gain access to the resources on the server.

Such issues have been widely discussed in the context of network technology, management, system administration and expandability, but it is necessary to find a practical solution for the problems mentioned earlier in order to create an efficient resource management model.

### SUMMARY OF THE INVENTION

The main object of the present invention is to provide (1) an Intranet platform that supports multiple message exchange protocols enabling users to link from the Intranet to the internet; (2) disk space on network drives for saving user data; and (3) program updates to tune the software and hardware installed at the user sites. The network server in accordance with the present invention is capable of realizing the concept of efficient management of computer resources.

The Intranet platform in accordance with the present invention comprises at least one application server and multiple endpoint machines.

The application server incorporating a set of standard message exchange protocols and data format has prepared several conversion units for input and output devices using different data format, such that systems using different data formats and message exchange protocols will be able to communicate with the host computer.

These endpoint machines can be personal computers or terminal machines with limited computing capabilities, but these machines have the capability to link up with the application server.

The above mentioned Intranet platform is not restricted by geographical region or distance. Client computers in different locations will be able to link up with the application server and gain access to network drives once the user identity has been verified and the predetermined authorization limit has been granted.

Users gaining access to network drives can download a copy of the selected software program or data to the registered endpoint machine.

The software programs and data can be converted to a machine readable format for a particular endpoint machine through the service of the conversion unit, so that endpoint machines running on different operating systems and message exchange protocols will be able to link up with the server without data compatibility problems.

The features and structure of the present invention will be more clearly understood when taken in conjunction with the accompanying figures.

### BRIEF DESCRIPTION OF THE DRAWINGS

FIG. 1 is a network platform according to the present invention;

FIG. 2 is the internal structure of application server;

FIG. 3 is a system diagram of the application server and endpoint machines;

FIG. 4 is a diagram of the application server linking with endpoint machines and other servers;

FIG. 5 is a structural diagram for a conventional Intranet;

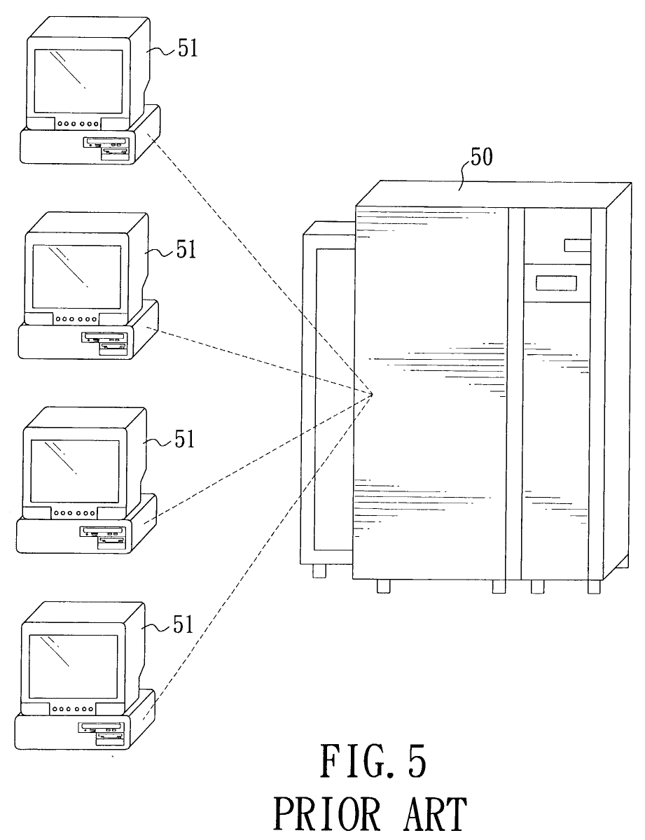

FIG. 6 is a second structural diagram for another conventional Intranet.

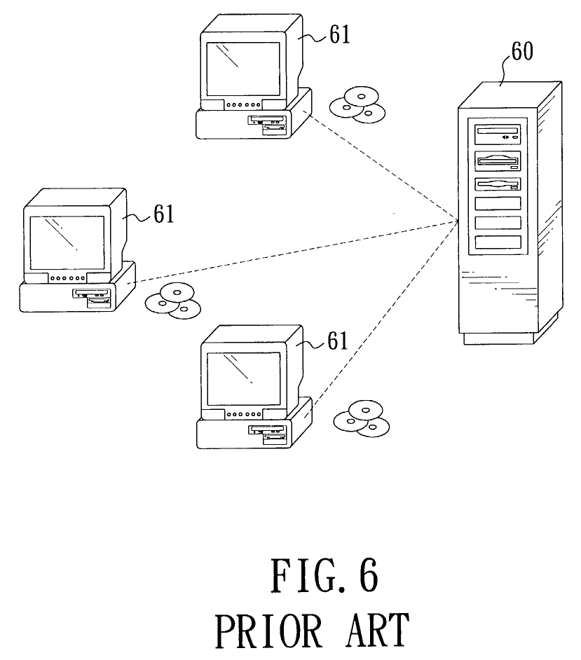

### DETAILED DESCRIPTION OF THE PREFERRED EMBODIMENT

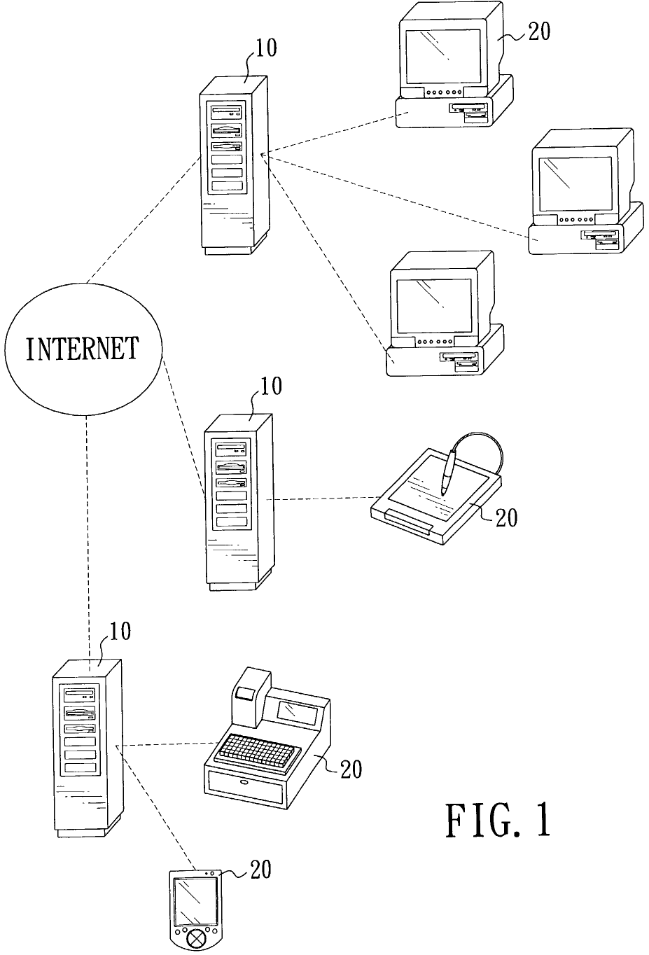

FIG. 1 shows an overall Intranet platform in which the present invention may be practiced. The scalable Intranet platform can be implemented in a distributed system environment with user sites spread over different geographical regions, and the Intranet platform supports most of the commonly used operating systems and message exchange protocols.

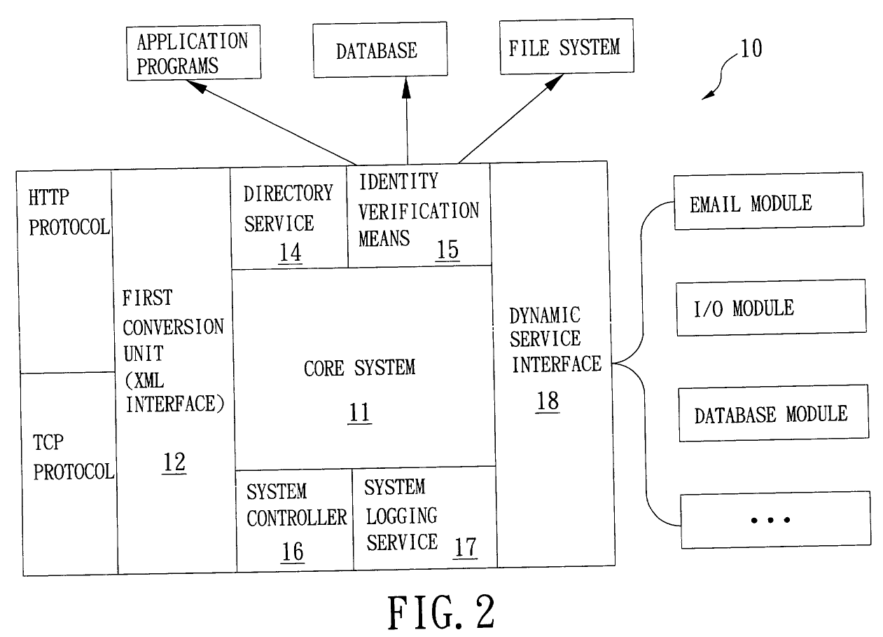

FIG. 2 shows the various components in the above-mentioned network, comprising:

at least one application server (10), including a core system (11), a system controller (16), a system logging service (17), a directory service (14), an identity verification means (15), and a first conversion unit (12).

The core system (10) has incorporated a set of standard data formats and language rules. For the current embodiment, the XML language rules are used in for cabled and wireless internet connections, whereby data are saved in the directory service (14) under the unified XML format.

The first conversion unit (12) is to provide a means for converting other data formats using different language rules to a format acceptable by the system during input or output operation. For the current embodiment, the first conversion unit (12) provides bidirectional data conversion from TCP or HTTP to XML format, or vice versa.

Multiple endpoint machines (20), which could be either a desktop computer, PDA or terminal machines with limited or no computing capabilities, are distributed across different geographical locations, wherein each endpoint machine (20) links to the application server (10) through the first conversion unit (12), forming a client-server connection. Each endpoint machine (20) is capable of establishing links with other network components under the Intranet architecture.

With reference to FIG. 2, the application server (10) can further include a dynamic service interface (18); enabling many widely used functional servers such as email module, I/O module, database module, etc. to be attached to the application server as additional elements.

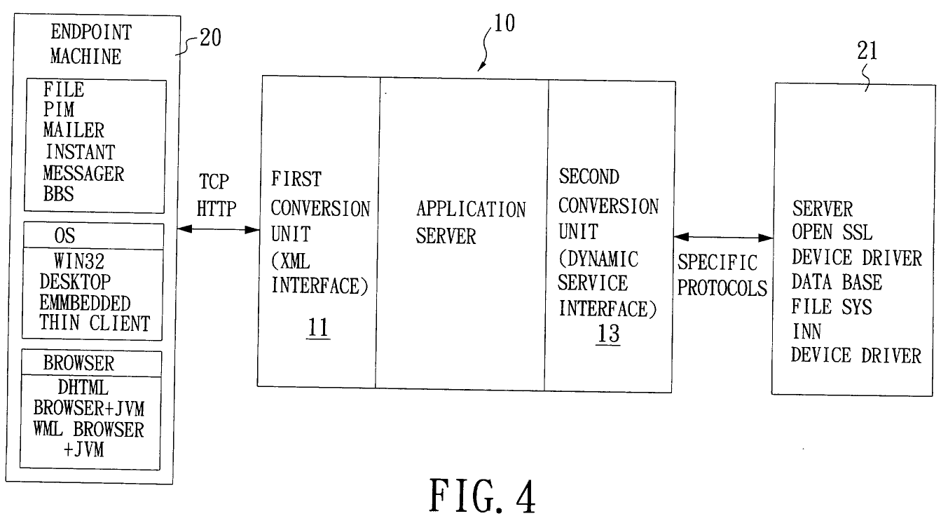

With reference to FIG. 4, with the addition of a second conversion unit (13), conventional functional servers (21) such as SSL server, database server, INN server, etc. can be installed on the application server (10). The second conversion unit (13) provides a gateway between the core system (11) using the standard data format and message exchange protocol and the functional servers (21) using different data formats and message exchange protocols, whereby the present network system can be expanded cross platform to functional servers on different domains.

Although there are many application programs in the application server (10), system administrators maintaining the application server (10) only need to be familiar with the standard language rules of the core system and update the program software for the application server (10). Endpoint machines (20) having successfully logged on to the application server (10) can download the most updated versions to fix any bugs or inconsistency in their machines. Therefore, the management of computer resources in the whole network can be accomplished with a few predefined steps.

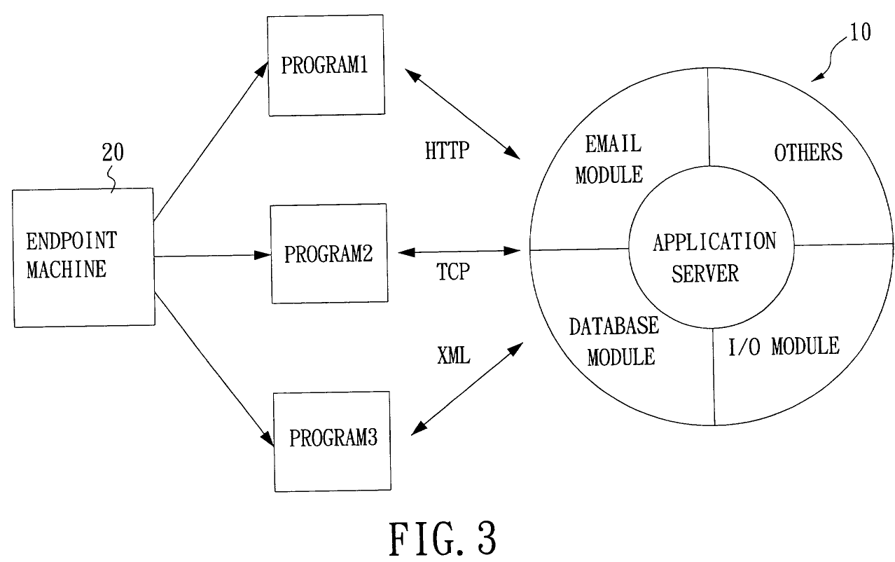

The application server (10) also has a system controller (16) and identity verification means (15), whereby different users are assigned different authorization limits. This authentication is designed to control the network resources in the most efficient manner, without having to monitor the activities over the network or keep track of the authorization levels currently assigned to endpoint machines. Once an endpoint machine has successfully logged on to the application server (10), the user information is recorded by the application server (10) and the endpoint machine (20) is thereafter granted a certain degree of freedom to access the program software stored in the application server (10). Users only need to search for the needed item in the software bank of the application server and download a copy to their machines. The endpoint machine (20) can then execute the program in the local environment as shown in FIG. 3. This downloading service enables users to obtain a copy of the program software when needed, without having to maintain a copy of the program in every endpoint machine.

The aforementioned Intranet platform is just an introduction based on a single system. The actual implementation of the network application is to be further discussed.

The application server (10) is capable of supporting many different message exchange protocols. The endpoint machine (20) shown in FIG. 4 can be a desktop computer, an embedded electronic device, or any other thin client, running on operating systems such as windows, Linux, Unix etc., and the browser can be DHTML+JVM or WML+JVM. Each endpoint machine can perform BBS or messaging on that particular operating system.

When an endpoint machine (20) invokes the browser, the data format and language rules are initially set up with HTTP format. When a message arrives at the application server (10), the message will be converted to XML by means of the first conversion unit (12) for data processing. The application server (10) can be further linked across to functional servers (21) in different domain through the dynamic service module of the second conversion unit (13), whereby the core system (11) will first convert the message into a data format and message exchange protocol supported by the specific functional server (21) through the second conversion unit (13) before outputting the message.

From the foregoing, it is clear that the present invention has created a highly scalable network platform that can accept different message exchange protocols. Through the distributed network services, the application server (10) provides many endpoint machines (20) with the necessary software for local program execution, without the addition of extra hardware or software.

Besides the network resources on the Intranet, the endpoint machines (20) are able to access the Internet through web servers and software overlay, thereby the vast collection of resources on the Internet can be used by the endpoint machines (20). Therefore the capabilities of the endpoint machines (20) are not restricted by the software content saved in the local disk, or even the existing network drives within the Intranet.

Through the identity verification means and system controller, the network administrator can set up different authorization limits for different users, such that network resources can be efficiently managed without unnecessary duplication of software and hardware, thus the system maintenance costs are considerably reduced.

The foregoing description of the preferred embodiments of the present invention is intended to be illustrative only and, under no circumstances, should the scope of the present invention be so restricted.

What is claimed is:

1. A scalable and intelligent network platform for distributed system, comprising
at least one application server, including a core system having a set of standard data formats and language rules, and a first conversion unit for converting different data formats and language rules to a system acceptable format through input/output units, or converting back to a particular data format and language rule for use on another system being connected to the network;
multiple endpoint machines logging onto the at least one application server from different geographical locations, wherein each endpoint machine connected to the at least one application server through the first conversion unit runs on its own operating system, can use different message exchange protocols and program software in the local environment; such that
the architecture mentioned above provides a common platform for linking various endpoint machines to an application server, whereby each endpoint machine can save data on network drives or download a copy of a selected program from the server database to its local machine, thereby all computer resources can be efficiently managed.

2. The scalable and intelligent network platform for distributed system as claimed in claim 1, wherein the network may further include multiple functional servers, provided that the application server has installed a second conversion unit for cross platform connection with functional servers in different domain using different message exchange protocols.

3. The scalable and intelligent network platform for distributed system as claimed in claim 1, wherein the application server includes a core system, a system controller, a system logging service, a directory service, an identity verification service and a first conversion unit; the core system contains a set of standard data formats and language rules; and the first conversion unit is used for converting different data formats and language rules to a system acceptable format through the input/output unit, or converting back to the particular data format and language rule for use on another system being connected to the network.

4. The scalable and intelligent network platform for distributed system as claimed in claim 2, wherein the application server can establish data communication with functional servers in different domain through the dynamic service module of the second conversion unit, by converting the message into a data format and a message exchange protocol suitable for the specific functional server before outputting the message.

5. The scalable and intelligent network platform for distributed system as claimed in claim 3, wherein the core system employs the XML language rules.

6. The scalable and intelligent network platform for distributed system as claimed in claim 4, wherein the core system employs the XML language rules.

7. The scalable and intelligent network platform for distributed system as claimed in claim 5, wherein the first conversion unit can support XML, TCP, HTTP message exchange protocols and conversion means associated therewith.

8. The scalable and intelligent network platform for distributed system as claimed in claim 6, wherein the first conversion unit can support XML, TCP, HTTP message exchange protocols and conversion means associated therewith.

9. The scalable and intelligent network platform for distributed system as claimed in claim 2, wherein the second conversion unit can perform conversion of data format and message exchange protocol to suit the requirements of the functional servers in different domain through the application server service handler of the second conversion unit.

10. The scalable and intelligent network platform for distributed system as claimed in claim 1, wherein the application server may further include an email module, an I/O module, and a database module.
